(19) United States
(12) Patent Application Publication
(10) Pub. No.: US 2015/0031011 A1
(43) Pub. Date: Jan. 29, 2015

(54) SYSTEMS, METHODS, AND COMPUTER-READABLE MEDIA FOR PROVIDING CONCEPT INFORMATION ASSOCIATED WITH A BODY OF TEXT

(71) Applicant: LTG Exam Prep Platform, Inc., Cambridge, MA (US)

(72) Inventor: Elad Shoushan, Cambridge, MA (US)

(21) Appl. No.: 14/265,215

(22) Filed: Apr. 29, 2014

Related U.S. Application Data
(60) Provisional application No. 61/876,372, filed on Sep. 11, 2013.
(60) Provisional application No. 61/816,835, filed on Apr. 29, 2013.

(51) Int. Cl. G06F 17/24; G09B 7/00

(52) U.S. Cl. CPC G06F 17/24; G09B 7/00
USPC 434/362; 434/322

(57) ABSTRACT

Systems, methods, and computer-readable storage media for providing concepts associated with a body of text are described. The body of text may be processed to determine whether words, symbols, phrases, or other elements thereof are keywords. For example, the elements of the body of text may be parsed using an expression dictionary. The keywords may be used to determine one or more concepts associated with the body of text and/or the keywords. For instance, the body of text may include a test question and the keywords may be configured to indicate concepts associated with the test question. A modified body of text may be provided to a user that includes highlighted keywords and/or other information embedded in the text that is associated with the keywords and/or concepts. A user may select the highlighted keywords and/or embedded information to access information associated with the selected keyword, such as concepts associated therewith.

### CROSS-REFERENCE TO RELATED APPLICATIONS

This application claims the benefit of U.S. Provisional Application Nos. 61/816,835, filed on Apr. 29, 2013, and 61/876,372, filed on Sep. 11, 2013, the contents of which are incorporated by reference in their entirety as if fully set forth herein.

### BACKGROUND

A standardized test is generally a test that is administered and scored in a consistent and standard manner in order to obtain reliable comparison of outcomes across all test takers. Standardized tests have been developed for a wide variety of test takers and test subjects. Common standardized tests include college and graduate program admissions test, such as the GMAT™, the GRE™, the SAT™, the LSAT™, and professional certification tests, such as the Fundamentals of Engineering (FE) test and state real estate salesperson exams. Standardized tests are designed such that the questions, administration conditions, scoring procedures, and interpretations are predetermined and standard.

Typical preparation for standardized tests includes the use of study books, courses, practice exams, and private tutoring. Students often study by memorizing concepts, rules, and vocabulary words associated with the standardized test. In addition, students also repeatedly solve many practice questions in order to identify the type of questions being tested, understand the concepts tested, select a solution strategy, and execute the selected strategy to answer the question. Students must complete these steps under severe time constrains. As such, students will generally receive better scores if they can learn and identify required test concepts faster and more accurately. For instance, for most standardized tests, there are a finite number of question patterns or types, which students can identify and master. The patterns may be based on a finite number of concepts that every test is designed to test. As such, it would be beneficial if a student had access to a system configured to enable the student to efficiently and effectively identify concepts associated with test questions and to implement strategies for answering test questions related to the concepts.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for providing at least one concept associated with a body of text may include a display, a processor in operable communication with the display, and a non-transitory, computer-readable storage medium in operable communication with the processor. The computer-readable storage medium may contain one or more programming instructions that, when executed, cause the processor to receive the body of text, determine at least one keyword within the body of text, determine at least one concept associated with the at least one keyword, and generate a concept-embedded body of text configured to be presented on the display, the concept-embedded body of text comprising embedded information indicating an association between the at least one keyword and the at least one concept.

In an embodiment, a computer-implemented method of providing at least one concept associated with a body of text may include, by a processor, receiving the body of text, determining at least one keyword within the body of text, determining at least one concept associated with the at least one keyword, and generating a concept-embedded body of text configured to be presented on a display operatively coupled to the processor, the concept-embedded body of text comprising embedded information indicating an association between the at least one keyword and the at least one concept.

In an embodiment, a computer-readable storage medium may include computer-readable program code configured to provide at least one concept associated with a body of text embodied therewith, the computer-readable program code may include computer-readable program code configured to receive the body of text, computer-readable program code configured to determine at least one keyword within the body of text, computer-readable program code configured to determine at least one concept associated with the at least one keyword, and computer-readable program code configured to generate a concept-embedded body of text configured to be presented on a display operatively coupled to the processor, the concept-embedded body of text comprising embedded information indicating an association between the at least one keyword and the at least one concept.

### BRIEF DESCRIPTION OF THE DRAWINGS

The above and other objects of the present invention will become more readily apparent from the following detailed description taken in connection with the accompanying drawings.

FIG. 1 depicts a text concepts presentation system according to some embodiments.

FIG. 2 depicts a flow diagram for an illustrative method of providing concepts associated with an input text string

FIGS. 3A and 3B depict an illustrative exam question according to an embodiment.

FIG. 4 depicts an illustrative exam preparation system according to some embodiments.

FIG. 5 depicts a flow diagram for an illustrative method of displaying concept information according to some embodiments.

FIGS. 6A-6E depict an illustrative exam practice session implemented according to some embodiments

FIG. 7 is a schematic block diagram of an exemplary embodiment of a computer system on which the systems and methods disclosed herein can be implemented.

The appended drawings are intended to better explain the foregoing summary, as well as the following detailed description of certain embodiments. For the purpose of illustration, certain embodiments are shown in the drawings. However, the scope of the subject matter of this disclosure is not limited to the arrangements and instrumentalities shown in the attached drawings.

### DETAILED DESCRIPTION

The described technology generally relates to providing information associated with a body of text. In some embodiments, the information may include concepts associated with the body of text. In some embodiments, the information may be based on one or more words within the body of text. For instance, each word within the body of text may be processed in order to determine whether the word is a designated keyword. Each keyword may be processed to determine which concepts are associated with the keyword. The body of text may be presented to a viewer, for instance, on a display of a computing device, with the keywords highlighted or otherwise demarcated to indicate that the keywords are associated with a concept. In some embodiments, the viewer may select a highlighted keyword to obtain a concept and/or concept information associated with the highlighted keyword.

In one non-limiting example, the body of text may include a standardized test question and the keywords may include words indicating the type or category of the question. In another non-limiting example, the body of text may include an article or section of a textbook, and the keywords may include words indicating the subject of the article or section of a textbook (for instance, economics, U.S. government, the Civil War, or the like). Although standardized tests are used as examples herein, embodiments are not so limited as any body of text capable of being used according to some embodiments are contemplated herein.

In some embodiments, a system (the “text concept system”) may be configured to implement a study methodology for bodies of text that include standardized test questions. In some embodiments, the text concept system may be configured to determine keywords in the standardized test questions that match one or more tested concepts and identify a tested pattern from these keywords. In some embodiments, the text concept system may be configured to receive and/or access a standardized test question. The text concept system may include a text-parsing engine configured to automatically analyze the text of the standardized test question to identify one or more keywords in the text that match keywords in a dictionary of the concepts being tested in that particular standardized test. The text-parsing engine may also be configured to provide processed text, including additional information that is embedded into the text around the one or more keywords that match to a tested concept.

Repeatedly presenting standardized test questions processed according to some embodiments to users may implement a study methodology that may help test-takers improve their identification of keywords, their ability to classify question types, their identification of tested concepts within practice questions, and their identification of repeating testing patterns. In this manner, the study methodology may be used by test-takers to practice questions in order to better identify question types, learn tested concepts, and repetitively solve questions in order to master specific concepts. As used herein, the terms “keyword” and “keywords” are used to generally refer to one or more of: single words, multiple words (whether contiguous or not), phrases, punctuation marks, characters, symbols, numbers, letters, sentence structures, combinations thereof, or the like.

In some embodiments, a computer-implemented method of automated identification of keywords associated with a body of text may include the following steps: 1) the text concepts presentation system receives a body of text; 2) the text concepts presentation system automatically analyzes the body of text to identify one or more keywords corresponding to the one or more concepts; 3) the text concepts presentation system automatically associates concept information about the identified one or more concepts to the keywords; and 4) the text concepts presentation system stores the body of text and the associated concept information, for example, in a digital storage form.

In some embodiments, a computer-implemented method of automated identification of keywords associated with concepts tested in a standardized test may include the following steps: 1) the text concepts presentation system receives a body of text in the form of a standardized test question; 2) the text concepts presentation system automatically analyzes the text of the standardized test question to identify one or more keywords corresponding to the concepts tested; 3) the text concepts presentation system automatically associates concept information about the identified one or more concepts to the keywords; and 4) the text concepts presentation system stores the body of text and the associated concept information, for example, in a digital storage form.

In some embodiments, a non-transitory computer-readable storage medium that has a set of instructions stored thereon, when executed, instructs a processor to implement a method of automated text parsing to identify keywords corresponding to concepts tested. The method includes the following steps: 1) the text concepts presentation system receives a body of text in the form of a standardized test question; 2) the text concepts presentation system automatically analyzes the text of the standardized test question to identify one or more keywords corresponding to the concepts tested; 3) the text concepts presentation system automatically associates concept information about the identified one or more concepts to the keywords; and 4) the text concepts presentation system stores the body of text and the associated concept information, for example, in a digital storage form.

In some embodiments, a system for associating standardized test questions with concept information may include a computer processor coupled to a memory, the processor may access programming instructions stored in the memory that may cause the processor to: provide an input module configured to receive a text string comprising a standardized test question, a parsing module configured to extract at least one keyword from the text string, a concept association module configured to look up the keyword in a test concept dictionary and determine whether the keyword is associated in the test concept dictionary with one or more test concepts, and an output module configured such that, when a keyword is determined to be associated in the test concept dictionary with a test concept, the output module outputs the text string with embedded information indicating an association between the keyword and the test concept.

In some embodiments, a method of associating standardized test questions with concept information using a computer processor may include, by a processor, receiving a text string comprising a standardized test question and extracting at least one keyword from the text string. The method may also include, by a processor, looking up the keyword in a test concept dictionary stored in a computer readable storage medium coupled to the processor and determining whether the keyword is associated in the test concept dictionary with one or more test concepts, and, responsive to a keyword being associated in the test concept dictionary with a test concept, outputting the text string with embedded information indicating an association between the keyword and the test concept to the storage medium.

In some embodiments, an exam preparation system may include a computer processor, an input device connected to the processor and configured to receive input from a user, an electronic display connected to the processor and configured to display an output to a user, and a memory storage device connected to the processor. The memory storage device may include (1) a test question repository that stores a test question for assessing the user's knowledge of a concept being tested and information embedded in the test question indicating an association between a keyword in the test question and the concept being tested, (2) a testing module configured to cause the processor to display the test question to the user using the display, (3) a highlighting module configured to cause the processor to highlight the keyword based on the information embedded in the test question using the display, and (4) a concept information module configured to cause the processor, in response to the user's selection of a highlighted keyword using the input device, to display on the display information regarding a concept associated with the selected keyword.

In some embodiments, a computer-implemented exam preparation method may include, by a processor, causing a test question comprising a text string to be presented to a user on an electronic display screen coupled to the processor, highlighting a keyword in the text string based on information embedded in the text string indicating an association between the keyword and a concept being tested. The method may also include, by the processor, receiving input information indicating a selection of a highlighted keyword from a user using the input device and causing the display of information regarding the concept associated with the selected keyword on the display screen.

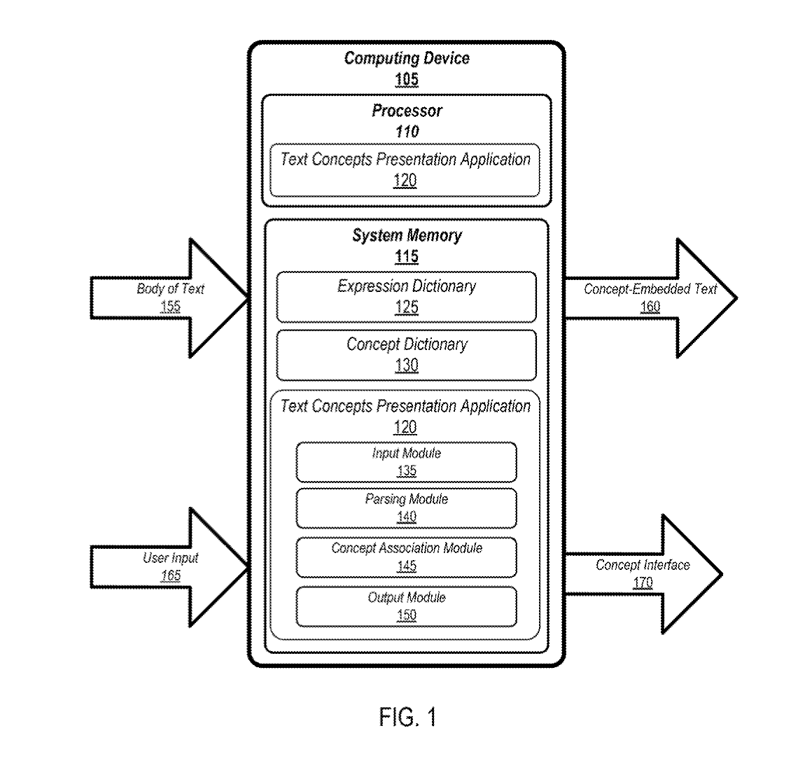

FIG. 1 depicts a text concepts presentation system according to some embodiments. As shown in FIG. 1, a text concepts presentation system may be implemented through a computing device 105 having a processor 110 and system memory 115. The computing device 105 may include one or more server computing devices, personal computers (PCs), kiosk computing devices, mobile computing devices, laptop computers, mobile phone devices, such as smartphones, tablet computing devices, automotive computing devices, personal digital assistants (PDAs), or any other logic and/or computing devices now known or developed in the future.

The processor 110 may be configured to execute a text concepts presentation application (the “application”) 120. The menu interface application 120 may include various modules, programs, applications, routines, functions, processes, components, or the like (“modules”) to perform functions according to some embodiments described herein. In some embodiments, the text concepts presentation application 120 may include an input module 135, a parsing module 140, a concept association module 145, and/or an output module 150. The system memory 115 may be configured to store and/or access an expression dictionary 125 and/or a concept dictionary 130. Although the expression dictionary 125 and the concept dictionary 130 are shown as being resident within the system memory 115 of the computing device 105, embodiments are not so limited as the expression dictionary and/or the concept dictionary may be located remote from the computing device. For example, the expression dictionary 125 and/or the concept dictionary 130, as well as any other information used by the application 120, may be located on a remote server (not shown).

In the illustrated embodiment, the text concepts presentation system (the “system”) may include an input module 135, a parsing module 140, a concept association module 145, and an output module 150. The system may be configured to receive a body of text (or “input text string”) 155. The body of text 155 may include any text, including a standardized test question, an article, a book, a computer program, or the like in any language. In some embodiments, the body of text 155 may include an input text string. In some embodiments, the body of text 155 may include a standardized test question and/or an answer set for a standardized test question.

The system may be configured to generate concept-embedded text (or “output text string”) 160 that includes the body of text 155 embedded with information and/or objects associated with keywords and/or concepts associated with the body of text. In some embodiments, the concept-embedded text 160 may include graphical user interface (GUI) objects, such as objects that may be selected through an input device. The system may be configured to receive user input 165. For instance, the concept-embedded text 160 may include highlighted keywords that may be selected by a user as indicated by the user input 165. The system may be configured to generate a concept interface 170 configured to present information, such as concept information, associated with the user input. For example, a user may select a keyword highlighted in the concept-embedded text 160, and the system may present a concept interface 170 depicting a concept associated with the selected keyword.

In some embodiments, the application 120 may be accessible through various platforms, such as a client application, a web-based application, over the Internet, and/or a mobile application (for example, a “mobile app” or “app”). According to some embodiments, the application 120 may be configured to operate on the computing device 105 and/or to operate on a server computing device accessible to the computing device over a network, such as the Internet. All or some of the files, data and/or processes used to process the body of text 150 may be stored locally on each computing device 105 and/or stored in a central location and accessible over a network. In addition, the various components of the system may be distributed across a plurality of computer processors, which may be coupled to one another, for instance, over a network, such as the Internet.

The input module 135 may be configured to receive the body of text 155. The body of text 155 may be received from a user and/or from an automatic process configured to provide a body of text to initiate a parsing process and/or other communication session. For example, a test question writer can use the system to enter a GMAT™ question and trigger execution of the parsing module 140. The body of text 155 may be provided in various ways, such as by an input device (for example, a keyboard, microphone, or the like), from a scanned image, or from a file or database. The user may contribute text, hyperlinks and/or other references to the content of the body of text 155, such as audio information, gestures, images, or the like. In some embodiments, information, functionality, preferences, concepts, expression dictionaries 125, concept dictionaries 130, or the like, may be used based on user identification, context, computing device 105, and so forth.

The parsing module 140 may be configured to extract at least one keyword from the body of text 155. For example, the parsing module 140 may extract one or more keywords from the body of text 155 by mapping the text string to the regular expression dictionary 125 or by suggesting keywords based on natural language processing algorithms. In some embodiments, the parsing module 140 may automatically identify one or more keywords, phrases, structures, symbols, or the like in the body of text 155 based on one or more expression dictionaries 125. In an exemplary embodiment, the parsing module 140 examines an entered question and recognizes a phrase or a word as one or more keywords (e.g., identifies the pronoun “them”, which refers to the concept “pronouns” that is tested on the GMAT™). The parsing module 140 can also process the input text string 155 by automatically recognizing the sentence structure (for instance, nouns, verbs, prepositions, punctuation, or the like).

The concept association module 145 is configured to look up keywords identified by the parsing module 140 in a test concept dictionary 130. The concept association module 145 is also configured to determine whether the keywords are associated in the test concept dictionary 130 with one or more test concepts. The test concept dictionary 130 can include relationship information that associates each of a plurality of test concepts with one or more keywords based on regular expressions that, when present in a test question or a test question answer, indicate that the test question is testing that concept. In some embodiments, all of the particular standardized test concepts that can be tested in a given type of standardized test are included in the test concept dictionary 130 in association with one or more keywords and/or regular expressions thereof. For example, the concept “Pronouns” is tested on the GMAT™. The concept of “Pronouns” may be included in a concept dictionary 130 and may match one or more regular expressions in the compatible regular expression dictionary 125. For example, the keywords “it” and “them” may match the concept “Pronouns.” In another example, the keywords “+,” “square root,” and “sufficient information” may be associated with the GMAT™ concept of “Data Sufficiency.”

The output module 150 may be configured such that, when a keyword in the body of text 155 is determined to match a regular expression associated in the test concept dictionary 130 with a test concept, the output module generates concept-embedded text 160 with embedded information indicating an association between the keyword and the test concept. The concept-embedded text 160 may be displayed to the user on an electronic display and/or saved to a database system or other storage system. The output module 150 may also display or save an analysis of the sentence structure of the body of text 155.

In some embodiments, the embedded information may include a markup language tag having parameters representative of at least one of a concept identifier (ID) uniquely associated with the test concept and a highlighting color uniquely associated with the test concept. The embedded information may also include a keyword ID uniquely associated with the keyword. In some embodiments, the embedded information may include protocol information associated with the keyword. In some embodiments, the protocol information may include references to one or more concepts associated with the keyword. The embedded information may also include an application action to which an expected regular expression corresponds. For example, information containing the conceptID, name, and not-used color can be generated and placed around the keyword. In some embodiments, the information can be generated based on Request for Comments (RFC) Internet protocol standards to map to an application interface. Hypertext markup language (HTML) compliant attributes or extensible markup language (XML) compliant attributes may provide extensibility, compatibility, and versioning management.

In some embodiments, when the test question is displayed to a user, keywords that relate to test concepts may be highlighted using a highlighting color specified in the embedded information. For example, parsing for a pronoun concept with “it” as a keyword, all pronoun keywords “it” within a sentence correction question may be highlighted in the same color. In some embodiments, a user may select a highlighted keyword to display information about the concept relating to the keyword on a concept interface 170. For example, information for answering “Pronoun” concept questions on the GMAT™ may be presented responsive to selection of the keyword “she.” In some embodiments, the standardized test question may also be displayed with a list of test concepts tested by the standardized test question, as well as highlighted keywords associated with said concepts.

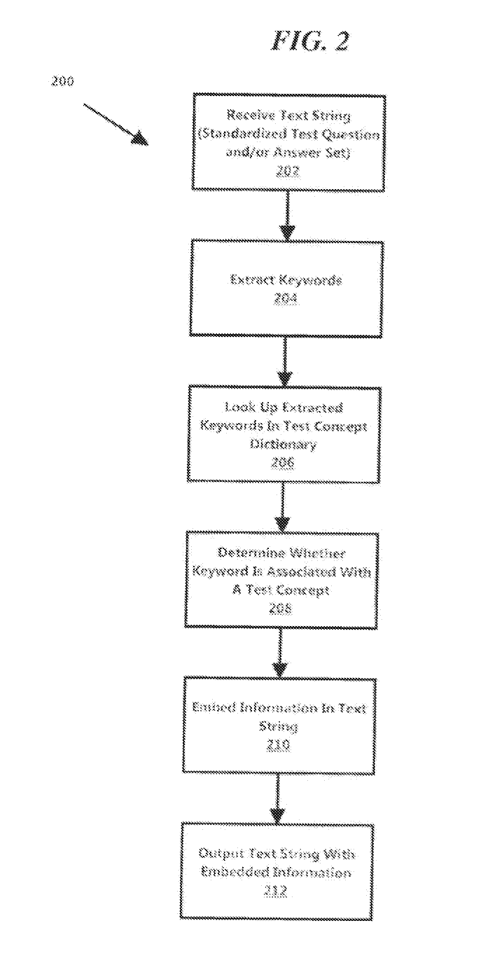

FIG. 2 depicts a flow diagram for an illustrative method of providing concepts associated with an input text string. While various methods disclosed herein are shown in relation to a flow diagram, the ordering of method steps implied by such flow diagrams or the description thereof is not to be construed as limiting the method to performing the steps in that particular order. Rather, the various steps of each of the methods disclosed herein may be performed in any of a variety of sequences. In addition, as the illustrated flow diagrams are merely exemplary embodiments, various other methods that include additional steps or include fewer steps are contemplated herein.

As shown in FIG. 2, the method 200 may be used to associate standardized test questions with concept information using a computer processor. For example, the method 200 may be used to process standardized test questions to identify one or more keywords associated with test concepts. The system receives 202 a text string comprising a standardized test question. The standardized test question may also include an answer set associated with the standardized test question, for instance, including at least one correct answer and at least one incorrect answer. In some embodiments, receipt of the text string may initiate or trigger the method 200.

The system may extract 204 at least one keyword from the text string, for example, by mapping the text string to the regular expression dictionary 125 and/or by executing one or more natural language processing algorithms. In some embodiments, the received standardized test question may be compiled and a syntax analysis may be performed on the standardized test question using the regular expression dictionary 125. For example, the standardized test question may be parsed and mapped to an expected regular expression. In some examples, one or more keywords may be linked to a tested concept.

The system may look up 206 the extracted keywords in the test concept dictionary 130 and determine 208 whether the keywords are associated in the test concept dictionary with one or more test concepts.

When a keyword is determined to be associated in the test concept dictionary 130 with a test concept, the system may embed 210 concept information into the text string. In some embodiments, the concept information may be configured to indicate an association between the keyword and the test concept. The system may output 212 the concept-embedded text 160 that includes the embedded concept information.

The concept-embedded text 160 can be stored in a standardized question store, such as a database, a file, or any other type of store. The processed test question can then be used by a test preparation system or in a test preparation method. For example, in some embodiments, the test question may be displayed with an answer set to a user (for example, using an electronic display), and the keywords can be highlighted using highlighting colors specified in the embedded information. When a keyword is selected by a user, information relating to a test concept corresponding to the keyword may be displayed to the user. In some embodiments, a standardized test question may be displayed with a list of test concepts tested by the standardized test question. In some embodiments, a standardized test question may be displayed with highlighting, or other demarcation, identifying keywords in the standardized test question that are associated with said concepts.

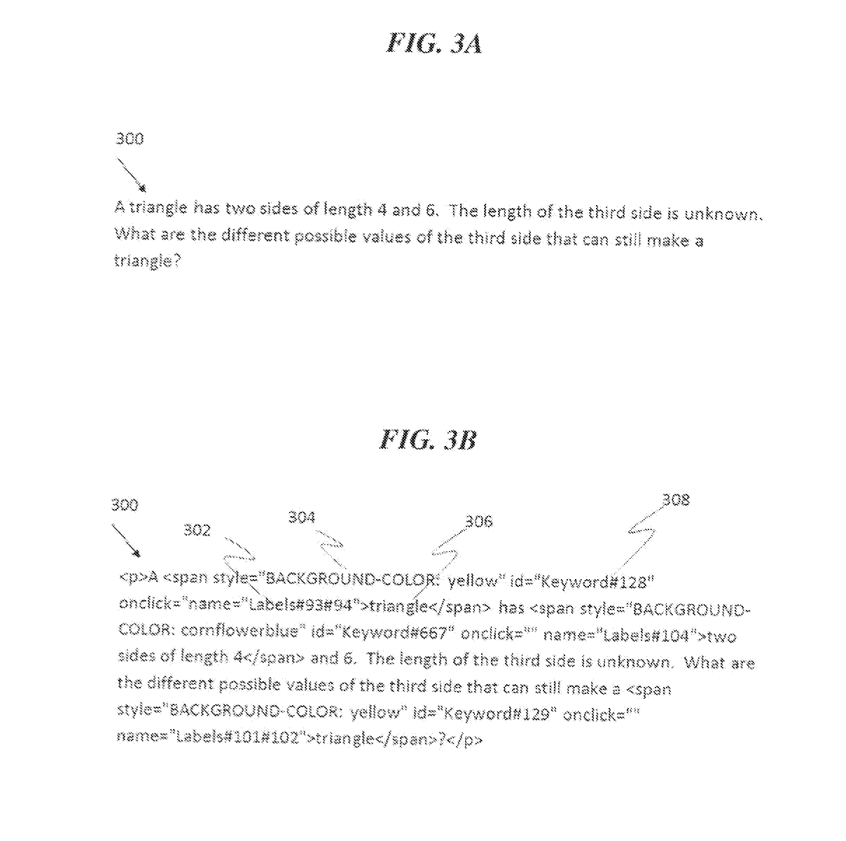

FIG. 3A depicts an illustrative test question 300. An answer set associated with the test question 300 is not shown for the sake of brevity; however, those having ordinary skill in the art will recognize that the test question may include an answer set and that the answer set may also be processed by the system and/or the method 200 according to some embodiments. As shown in FIG. 3A, the test question 300 may include a text string without any concept information. FIG. 3B depicts the test question 300 of FIG. 3A processed according to some embodiments. As shown in FIG. 3B, the test question 300 has been parsed, processed, and extended to include information around identified keywords or phrases. For example, a keyword 306 (“triangle”) has been identified and assigned a unique ID 308 (“#128”). The keyword 306 may also be matched to associated standardized test concepts. In some embodiments, a standardized test question may be displayed with various labels or other information (“#93#94”) from the test concept dictionary. In some embodiments, a standardized test question may be displayed with a concept-unique background color 304 (“yellow”). The question 300 in FIG. 3B may include a protocol message that is embedded around a detected keyword, thereby transforming the unprocessed keyword to an actionable keyword in a standardized test question.

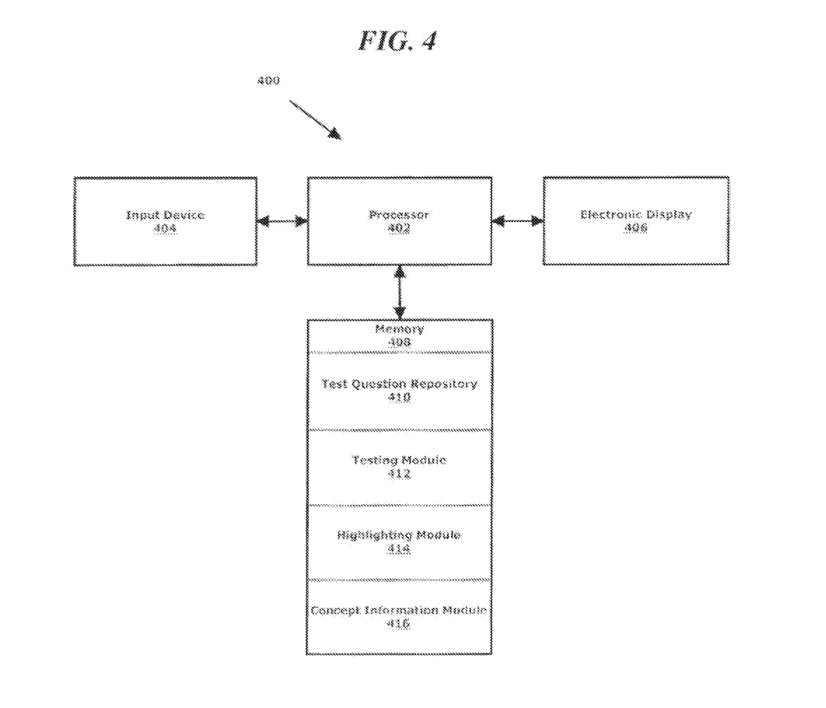

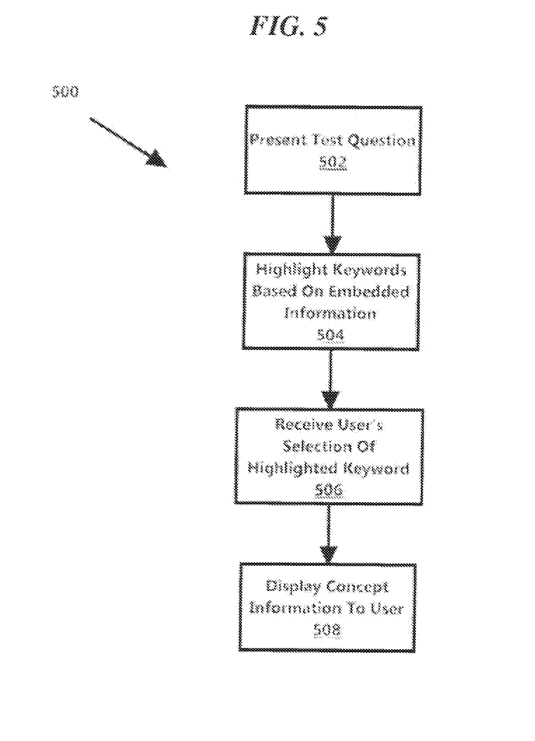

FIG. 4 depicts an illustrative exam preparation system according to some embodiments. As shown in FIG. 4, the system 400 may include a processor 402, an input device 404, an electronic display 406, and a memory 408. The memory 408 may be configured to store a test question repository 410, a testing module 412, a highlighting module 414, and/or a concept information module 416. The input device 404 may be operatively coupled to the processor 402 and may be configured to receive input from a user. The electronic display 406 may be operatively coupled to the processor 402 and may be configured to display an output to a user.

The test question repository 410 may store one or more test questions for assessing the user's knowledge of a concept being tested. The repository 410 may also store information embedded in the test questions indicating associations between keywords (for instance, words, phrases, structures, or the like) in the test question and concepts being tested. The test questions may include corresponding answer sets, the answer sets having at least one correct answer and at least one incorrect answer. The answer sets may also include embedded information indicating associations between keywords in the answers and concepts being tested.

The testing module 412 may be configured to cause the processor 402 to display test questions to the user using the display 406 and to perform various other tasks relating to test administration. Such tasks may include, without limitation, eliciting an answer to a test question from a user, determining whether the answer is correct or incorrect, storing a user's answer history, performing analytics on the user's answer history and answer patterns, or the like.

The highlighting module 414 may be configured to cause the processor 402 to highlight keywords in the test question based on the information embedded in the test question. For example, keywords relating to a first concept can be highlighted using a first color, and keywords relating to a second concept can be highlighted using a second color. In this manner, the keywords or phrases associated with each concept being tested in a particular question can be highlighted using a concept-unique color. In some embodiments, highlighting may be toggled on and off in response to a user's actuation of a user interface element (for instance, a button, slide bar, or the like). The system 400 may also be configured to display the test question (and any associated answer set) with a list of concepts tested by the test question. The user can then select a particular concept to cause the highlighting module 414 to highlight only the keywords associated with the selected concept.

The concept information module 416 may be configured to cause the processor 402, in response to the user's selection of a highlighted keyword using the input device 404, to present on the display 406 information regarding a concept associated with the selected keyword. Thus, when a user selects a highlighted keyword or phrase, information relating to the underlying concept can be presented to the user. In some embodiments, the user may be presented with a virtual flashcard, with the concept name on one side and a detailed description of the concept on the other side.

FIG. 5 depicts a flow diagram for an illustrative method for displaying concept information according to some embodiments. The method 500 can be used to facilitate exam preparation by a user using a computer processor. At step 502, the system 500 may present a test question comprising a text string to a user on the electronic display screen. The test question can include a question portion and an answer set having at least one correct answer and at least one incorrect answer.

At step 504, keywords in the text string may be highlighted based on information embedded in the text string indicating an association between the keywords and one or more concepts being tested. As noted above, the keywords can be selectively highlighted based on actuation of a user interface element by the user. The information embedded in the test question can indicate an association between a plurality of keywords in the test question and a plurality of respective concepts being tested. At step 506, the user's selection of a highlighted keyword using the input device may be received. At step 508, the system may display information regarding the concept associated with the selected keyword. In some embodiments, the method 500 may also include displaying the test question with a list of concepts tested by the test question. The user can then select a concept from the list of concepts, at which time the system may highlight only the keywords associated with the selected concept.

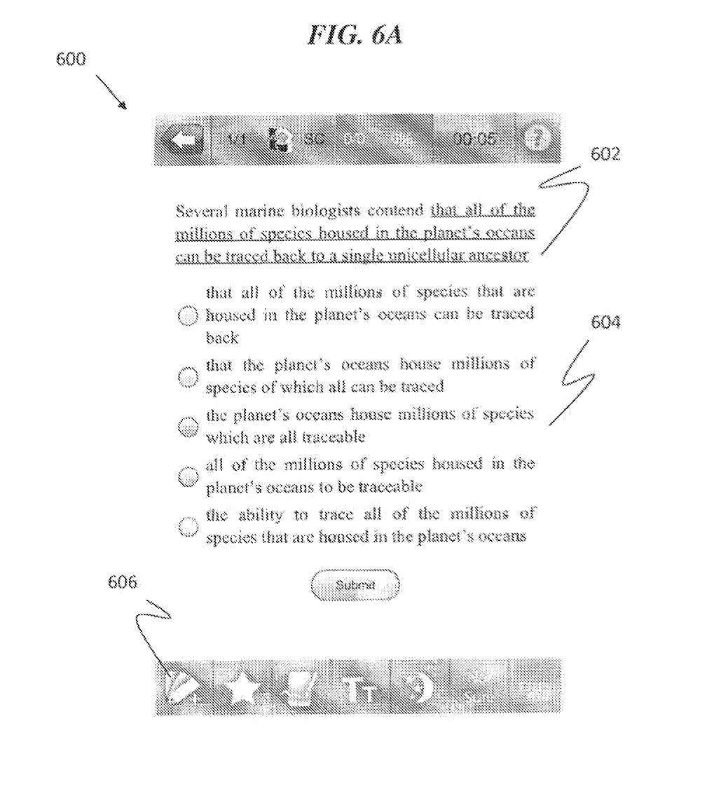

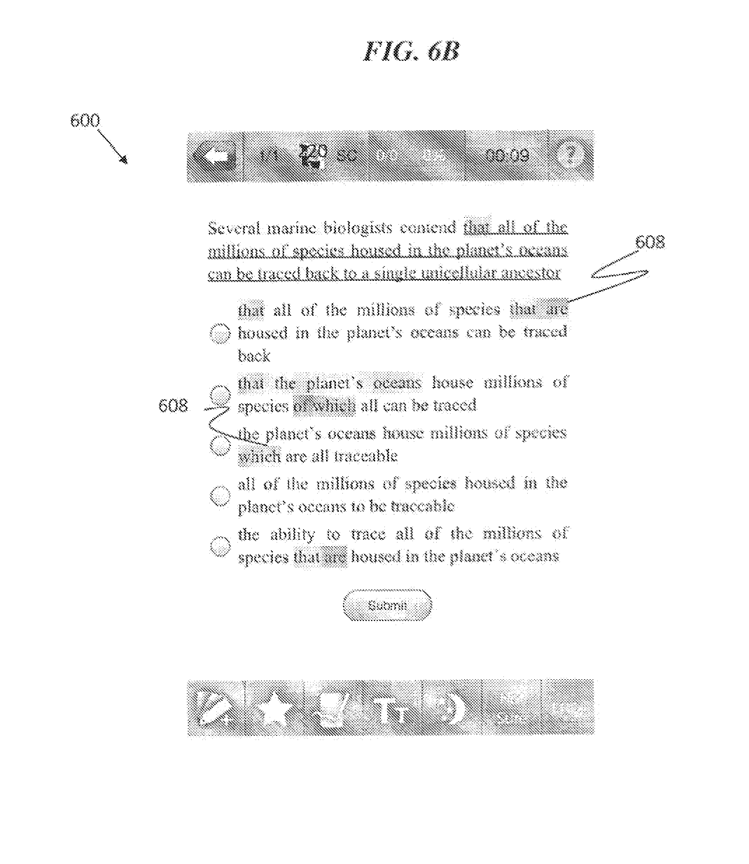

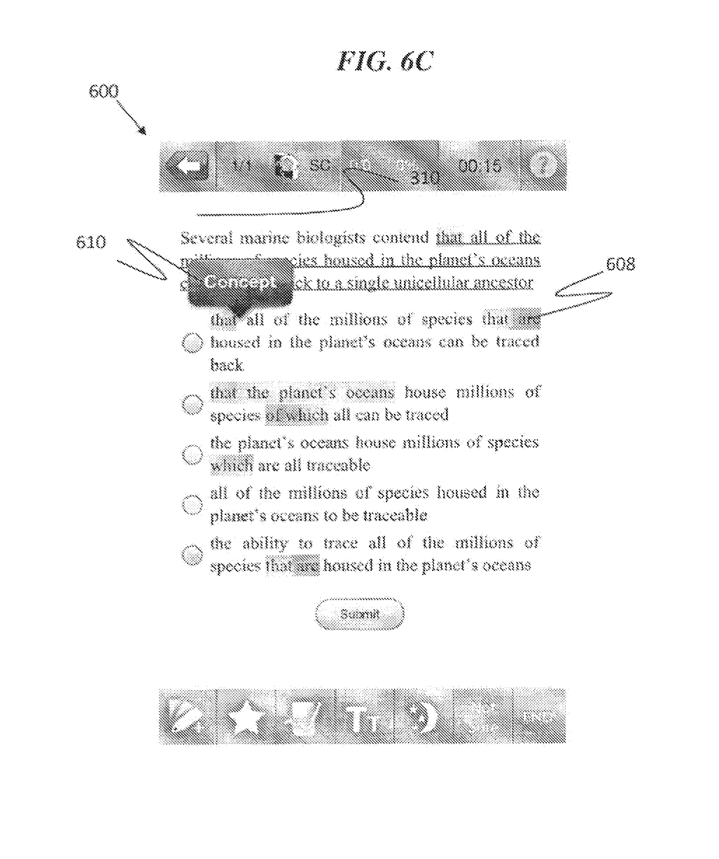

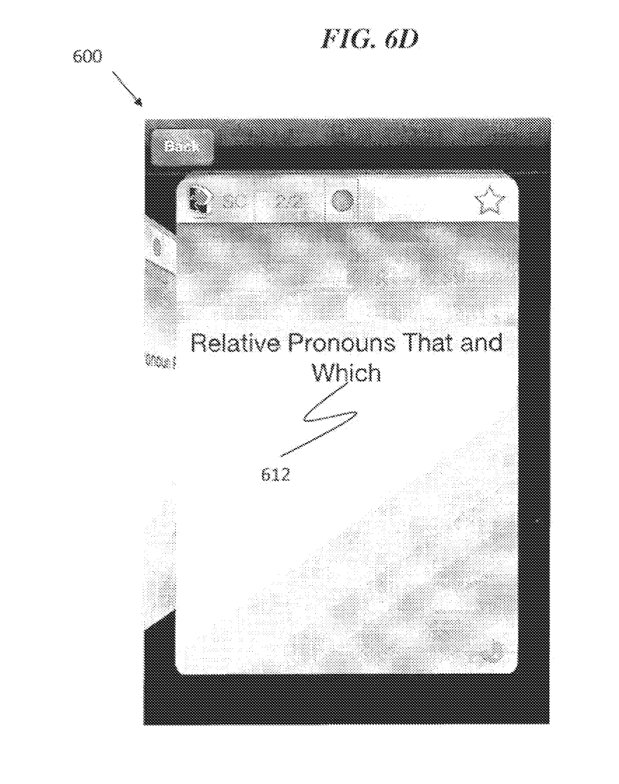

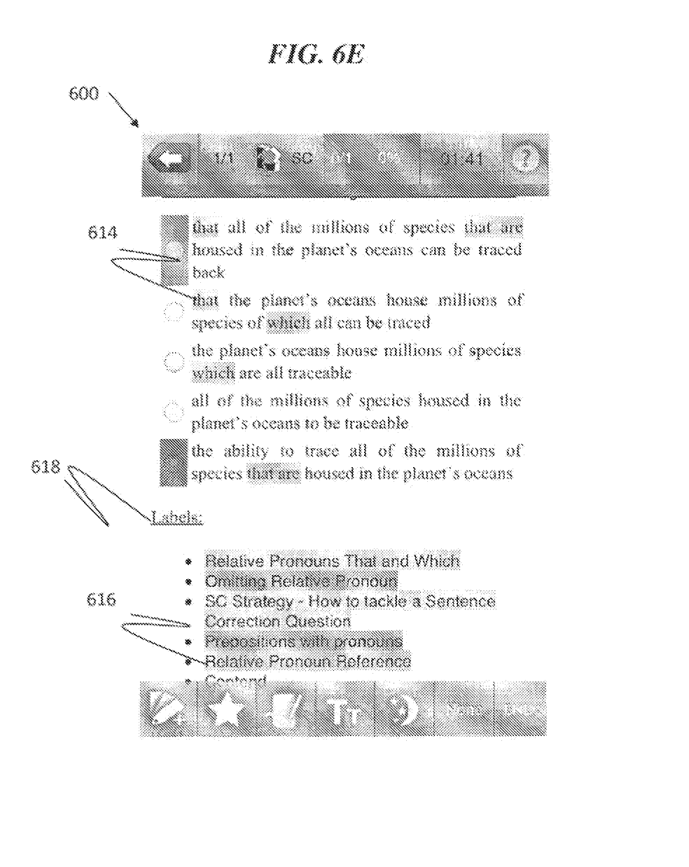

FIGS. 6A-6E depict an illustrative exam practice session implemented according to some embodiments. In particular, FIGS. 6A-6E depict an example of a GMAT™ sentence correction question. Referring to FIG. 6A, a user has opened an application that implements the system on a computer system (for instance, the LTG Prep4Gmat Exam application provided by LTG Exam Prep Platform Inc.) and initiated a practice session. A question may be presented within the practice session screen 600 and may include various parts, including, without limitation, a question text 602 followed by a number of answer choices 604 of which a user can select one and submit it to the system. The practice session screen 600 may contain other elements, such as an action bar 606 at the bottom of the screen that may include various buttons for providing certain application functions. For example, the action bar 606 may include a Show Keywords Button configured to hide/reveal the keywords associated with a question. A user may select the Show Keywords Button before or after selecting the correct answer choice.

Referring to FIG. 6B, the system has exposed the highlighted keywords 608 in the different parts of the question in both the question text and the answer choices. In addition, the system has colored a set of keywords that are associated with the same concept in the same color, creating a visual colorful pattern within the question. The system allows the user to click on any highlighted keyword. The highlighted keywords may be at least a portion of the concept-embedded text 160 of the system. Each color may imply a different concept, creating a visual colored pattern of tested concepts.

In FIG. 6B, the keyword “contend” is highlighted using a first color or pattern (for example, light blue), the keyword “that” in the question portion is highlighted using a second color or pattern (for example, yellow), the keywords “that” and “which” in the answer portion are highlighted using a third color or pattern (for example, gray), the keyword “are” is highlighted using a fourth color or pattern (for example, bright blue), the key phrase “the planet's oceans” is highlighted using a fifth color or pattern (for example, purple), and the keyword “of” is highlighted using a sixth color or pattern (for example, green).

Referring to FIG. 6C, a user can select one or more keywords 608 during a practice session. In response to the selection of keywords, the system may present a clickable menu item 610 titled “concept” to reveal the concept tested. For example, a user can select the highlighted keyword “that,” which is associated with a concept that tests usage of the relative pronouns “that” and “which.”

Referring to FIG. 6D, a matching engine of the system may translate a user selection and present a flashcard 612 with the concept associated to the selected keyword. Concepts can be presented in any visual or audible way—flashcard, multimedia, sound, etc. For example, the concepts presentation(s) can be performed by a collaborating user's mobile device (e.g., Apple iPhone™, Apple iPad™, BlackBerry™ smartphone, and/or other smart phone, handheld devices, tablet, laptop, etc.). Clicking the concept pop-up brings up the flashcard with the theory of the concept tested.

Referring to FIG. 6E, a fully solved sentence correction question is shown in which keywords 614 of a concept 616 are highlighted, both in the question section and in the answer choices section. For example, after selecting an answer choice and submitting it to the system, the Labels section 618 lists all the concepts tested within this question. Each listed concept is highlighted using a different color. In FIG. 6E, the user has clicked on or otherwise selected the “Relative Pronoun Reference” concept 616, and in response the system removes all highlighted keywords except for the ones 614 associated with that particular concept. The keywords associated with a particular concept are highlighted using the same color used to highlight the concept itself in the list of concepts 616.

One or more of the examples described herein refer to the GMAT™ exam; however the systems and methods disclosed herein are not limited solely to the GMAT™ exam, but rather can be used with any available standardized test that presently exists or is developed in the future, or any written text in any form, medium, or format, and in any language.

While color highlighting is described herein as a mechanism for visualizing texts or concepts in test question text, other techniques can be used instead or in addition, such as images, monochromatic highlighting, popups, audible cues, etc.

In view of the foregoing, it will be appreciated that the methods and devices disclosed herein can provide a number of advantageous technical effects, a number of examples of which are set out below.

In some embodiments, the systems and methods disclosed herein may facilitate learning of standardized testing methodologies and can simplify the user experience during a practice session. While current practicing tools offer basic approaches, such as by providing hyperlinks and other mechanisms to link the content of questions, the approach embodied in the disclosed systems and methods can provide an engine to process the content of standardized test questions and wrap keywords with protocol information that contains references to one or more of the concepts associated with the identified keyword. For example, if a standardized test question contains one or more instances of the pronoun “it” (within the question text or any of the answer choices), the text that has been processed by the text parser engine will automatically prompt the one or more associated concepts in a flashcard and present the results of the request to the user. The user can then browse through the concepts to better comprehend the concept tested.

The systems and methods disclosed herein can also facilitate solving a standardized question when a text parser engine identifies a pattern. For example, in some embodiments, after parsing a standardized test question, a user may: 1) review the highlighted keywords (usually using, but not limited to, a handheld device screen), 2) interpret the concept, 3) eliminate allegedly incorrect answer choices, and 4) pick the correct answer according to his understanding. This example will often be more complex because current standardized test questions contain extensive information, test many different concepts, and feature many keywords. To interpret these patterns, users must follow a workflow, where each step of the workflow presumes that the user has a strong grasp of the concepts measured in a particular standardized test. The systems and methods disclosed herein can help a user follow a strict workflow by creating visual or audible stimulus, such as (but not limited to) highlighting keywords and presenting concepts in flashcards.

The systems and methods disclosed herein according to some embodiments may provide a text-parsing engine output that helps trigger actions in one or more applications based on the identified concepts. For example, if the generated information around an identified keyword contains “Label#5#6”, an external component can take action related to Label 5 and Label 6 (for example, displaying a flashcard) when the keyword is selected by a user. Thus, the systems and methods disclosed herein can enhance the practice experience and allow users to focus on understanding the question patterns and concepts, while the application streamlines the users' actions, e.g., in the form of clicking, voice commanding, hand gesturing, eye blinking, etc.

Following a pattern revealed by the automated text-parsing engine can help improve test taker performance by focusing on the tested concepts and executing the solution. Using automated text processing, a user can perform precise analysis and/or other actions with respect to text processing that could be tedious if the question contains a lot of text or high-level language. Enabling the keywords helps the user to focus on specific highlighted keyword(s), eliminating unnecessary text noise and allowing the user to decide whether the keywords comply with grammar rules, correct sentence structure, and logic. The systems and methods disclosed herein can also create a unique flow of standardized test questions in a practice session. Such practice sessions can be initiated by a single user or multiple users. In some embodiments, the system is not limited to a single user, and allows social learning and/or collaboration between one or more users.

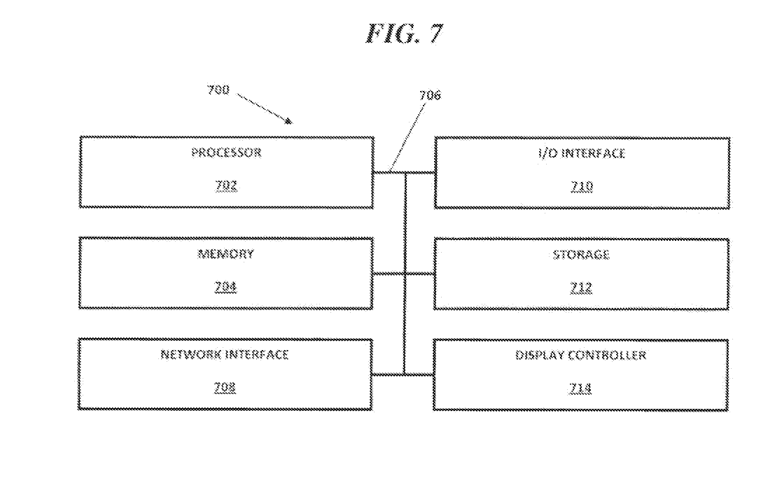

FIG. 7 illustrates an exemplary architecture of a computer system 700 which can be used to implement the systems and/or methods disclosed herein. Although an exemplary computer system 700 is depicted and described herein, it will be appreciated that this is for the sake of generality and convenience. In other embodiments, the computer system may differ in architecture and operation from that shown and described here.

The computer system 700 can include a processor 702 which controls the operation of the computer system 700, for example by executing an operating system (OS), device drivers, application programs, and so forth. The processor 702 can include any type of microprocessor or central processing unit (CPU), including programmable general-purpose or special-purpose microprocessors and/or any of a variety of proprietary or commercially-available single or multiprocessor systems.

The computer system 700 can also include a memory 704, which provides temporary or permanent storage for code to be executed by the processor 702 or for data that is processed by the processor 702. The memory 704 can include read-only memory (ROM), flash memory, one or more varieties of random access memory (RAM), and/or a combination of memory technologies.

The various elements of the computer system 700 can be coupled to one another. For example, the processor 702 can be coupled to the memory 704. The various elements of the computer system 700 can be directly coupled to one another or can be coupled to one another via one or more intermediate components. In the illustrated embodiment, the various elements of the computer system 700 are coupled to a bus system 706. The illustrated bus system 706 is an abstraction that represents any one or more separate physical busses, communication lines/interfaces, and/or multi-drop or point-to-point connections, connected by appropriate bridges, adapters, and/or controllers.

The computer system 700 can also include a network interface 708 which enables the computer system 700 to communicate with remote devices (e.g., other computer systems) over a network or communications channel. Exemplary networks/communications channels include Wi-Fi networks, the Internet, cellular data networks, near field communications, Bluetooth®, USB, and so forth.

The computer system 700 can also include an input/output (I/O) interface 710 which facilitates communication between one or more input devices, one or more output devices, and the various other components of the computer system 700. Exemplary input and output devices include keypads, touchscreens, buttons, lights, speakers, and so forth.

The computer system 700 can also include a storage device 712, which can include any conventional medium for storing data in a non-volatile and/or non-transient manner. The storage device 712 can thus hold data and/or instructions in a persistent state (i.e., the value is retained despite interruption of power to the computer system 700). The storage device 712 can include one or more hard disk drives, flash drives, USB drives, optical drives, various media disks or cards, and/or any combination thereof and can be directly connected to the other components of the computer system 700 or remotely connected thereto, such as over a network.

The computer system 700 can also include a display controller 714 which can include a video processor and a video memory, and can generate images to be displayed on one or more displays in accordance with instructions received from the processor 702.

The various functions performed by the systems and methods disclosed herein can be logically described as being performed by one or more modules. It will be appreciated that such modules can be implemented in hardware, software, firmware, or a combination thereof. It will further be appreciated that, when implemented in software, modules can be part of a single program or one or more separate programs, and can be implemented in a variety of contexts (e.g., as part of an operating system, a device driver, a standalone application, and/or combinations thereof). In addition, software embodying one or more modules can be stored as an executable program on one or more non-transitory computer-readable storage mediums. Functions disclosed herein as being performed by a particular module can also be performed by any other module or combination of modules, and systems and methods disclosed herein can include fewer or more modules than what is shown and described.

Exemplary computer systems on which the system and methods disclosed herein can be implemented include handheld devices, smartphones, tablets, mobile devices, PDAs, televisions, laptop computers, desktop computers, server computers, handheld computers, Google Glasses™, Apple iPhone™, Apple iPad™, Google Android™ phones or tablets, and the like.

In some embodiments, the systems and methods disclosed herein can be implemented using coded instructions (e.g., computer readable instructions) stored on a tangible or non-transitory computer readable medium such as a flash memory, a read-only memory (ROM), a random-access memory (RAM), a CD, a DVD, a Blu-ray, a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

In some embodiments, the systems and methods disclosed herein can be implemented using any combination(s) of application specific integrated circuit(s) (ASIC(s)), programmable logic device(s) (PLD(s)), field programmable logic device(s) (FPLD(s)), field programmable gate array(s) (FPGA(s)), discrete logic, hardware, firmware, etc. Any or all of the example methods disclosed herein can be performed sequentially and/or in parallel by, for example, separate processing threads, processors, devices, discrete logic, circuits, etc.

In some embodiments, the systems and methods disclosed herein can be distributed across a plurality of computer systems in communications coupling with one another, with one computer system performing one or more functions and another computer system or systems performing other functions. Embodiments may thus be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A system for providing at least one concept associated with a body of text, the system comprising:
a display;
a processor in operable communication with the display; and
a non-transitory, computer-readable storage medium in operable communication with the processor, wherein the computer-readable storage medium contains one or more programming instructions that, when executed, cause the processor to:
receive the body of text,
determine at least one keyword within the body of text,
determine at least one concept associated with the at least one keyword, and
generate a concept-embedded body of text configured to be presented on the display, the concept-embedded body of text comprising embedded information indicating an association between the at least one keyword and the at least one concept.

2. The system of claim 1, wherein the embedded information is configured as at least one highlighted word.

3. The system of claim 2, further comprising:
at least one input device in operable communication with the at least one processor,
wherein the computer-readable storage medium further contains one or more programming instructions that, when executed, cause the processor to:
receive selection information associated with selection of the at least one highlighted word from the at least one input device, and
generate a concept information interface configured to be presented on the display, the concept information interface being configured to display the at least one concept associated with the at least one highlighted word.

4. The system of claim 1, wherein the body of text comprises a test question.

5. The system of claim 4, wherein the at least one concept comprises a concept tested by the test question.

6. The system of claim 1, wherein the at least one keyword is determined by mapping the body of text to a regular expression dictionary.

7. The system of claim 1, wherein the computer-readable storage medium further contains one or more programming instructions that, when executed, cause the processor to generate embedded information associated with the at least one keyword and the at least one concept.

8. The system of claim 7, wherein the embedded information comprises a keyword identifier uniquely associated with the at least one keyword.

9. A computer-implemented method of providing at least one concept associated with a body of text, the method comprising, by a processor:
receiving the body of text;
determining at least one keyword within the body of text;
determining at least one concept associated with the at least one keyword; and
generating a concept-embedded body of text configured to be presented on a display operatively coupled to the processor, the concept-embedded body of text comprising embedded information indicating an association between the at least one keyword and the at least one concept.

10. The method of claim 9, wherein the embedded information is configured as at least one highlighted word.

11. The method of claim 10, further comprising, by the processor:
receiving selection information associated with selection of the at least one highlighted word from at least one input device operatively coupled to the processor, and
generating a concept information interface configured to be presented on a display operatively coupled to the processor, the concept information interface being configured to display the at least one concept associated with the at least one highlighted word.

12. The method of claim 9, wherein the body of text comprises a test question.

13. The method of claim 12, wherein the at least one concept comprises a concept tested by the test question.

14. The method of claim 9, wherein the at least one keyword is determined by mapping the body of text to a regular expression dictionary.

15. The method of claim 9, further comprising, by the processor, generating embedded information associated with the at least one keyword and the at least one concept.

16. The further comprising, by the processor of claim 15, wherein the embedded information comprises a keyword identifier uniquely associated with the at least one keyword.

17. A computer-readable storage medium having computer-readable program code configured to provide at least one concept associated with a body of text embodied therewith, the computer-readable program code comprising:
computer-readable program code configured to receive the body of text;
computer-readable program code configured to determine at least one keyword within the body of text;
computer-readable program code configured to determine at least one concept associated with the at least one keyword; and
computer-readable program code configured to generate a concept-embedded body of text configured to be presented on a display operatively coupled to the processor, the concept-embedded body of text comprising embedded information indicating an association between the at least one keyword and the at least one concept.

18. The computer-readable storage medium of claim 17, wherein the body of text comprises a test question.

19. The computer-readable storage medium of claim 18, wherein the at least one concept comprises a concept tested by the test question.

20. The computer-readable storage medium of claim 17, wherein the at least one keyword is determined by mapping the body of text to a regular expression dictionary.
